(19) United States
(12) Patent Application Publication
(10) Pub. No.: US 2012/0312857 A1
(43) Pub. Date: Dec. 13, 2012

(54) FASTENER DRIVING APPARATUS

(75) Inventors: Mario GRAZIOLI, Chur (CH); Tilo Dittrich, Feldkrich (AT)

(73) Assignee: Hilti Aktiengesellschaft, Schaan (LI)

(21) Appl. No.: 13/316,918

(22) Filed: Dec. 12, 2011

(30) Foreign Application Priority Data
Dec. 13, 2010 (DE) 102010062895.6

(51) Int. Cl. B25C 1/14

(52) U.S. Cl. 227/10

(57) ABSTRACT

The invention concerns a fastener driving apparatus comprising a tank for storage of a fuel, particularly liquefied gas, a combustion chamber (3) connected to the tank via a valve element, where the combustion chamber has a movable piston (1) to advance a driving ram (4), and an ignition device to ignite an air-fuel mixture in the combustion chamber (3), where an active electrically driven evaporation element (8) is provided in a region (6, 7) of a supply line for the fuel.

The invention concerns a fastening driving apparatus, in particular a hand-operated driving apparatus, according to the generic part of claim 1.

U.S. Pat. No. 4,712,379 describes a liquefied gas-driven driving apparatus with a combustion chamber for ignition of a liquefied gas-air mixture, through which a piston with adjacent driving ram is advanced, in order to drive a nail or the like into a workpiece. A tank for storage of the liquefied gas is adjacent to a valve element for dispensing the liquefied gas. From the valve element the liquefied gas goes via an injection line into the combustion chamber.

In general with fastener driving devices of this kind it is necessary that the liquefied gas, after being dispensed through the valve element, evaporate in a short enough time to guarantee ergonomic and reliable operation. This applies in particular at unfavorably low ambient temperatures, for example when working outside in winter.

It is the task of the invention to specify a fuel-driven fastener driving apparatus in which a delay time preceding the ignition operation is minimized.

For a driving apparatus of the kind mentioned at the start, this task is solved in accordance with the invention with the characterizing features of claim 1. Through the electrically driven evaporation element, an amount of energy can be transmitted from an electric energy source to the fuel in a controlled way in order to achieve sufficiently rapid evaporation and/or mixing of the fuel with the combustion air, especially under unfavorable ambient conditions. A fuel line going to the combustion chamber, an opening of such fuel line into the combustion chamber, or the combustion chamber itself, for example, is understood as the region for introduction of the fuel into the combustion chamber.

An electrical energy source for the operation of the electrical evaporation element can be provided in order to satisfy a number of tasks, for example the electronic ignition of the fuel-air mixture, too. Preferably, rechargeable batteries, such as are usually used in the case of hand-operated tools, are used.

In a preferred embodiment of the invention the evaporation element comprises an electrical heating element. The introduction of heat energy via an electrical heating element is a simple and direct possibility for accelerating the evaporation of the fuel.

In an especially preferred development, the heating element is a PTC (positive temperature coefficient) heater. Because the resistance rises with temperature, such heating elements are self-regulating, so that overheating, particularly the danger of unintended ignition of the fuel, is excluded by design. Alternatively, however, traditional heating elements with heating coils can be used.

In an alternative or supplemental embodiment, the heating element comprises a means for generation of mechanical oscillations. Preferably, but not necessarily, it is a high-frequency or ultrasonic generator. Through this, in each case according to arrangement, an especially rapid transmission of energy to the fuel for purposes of evaporation or mixing can take place. For example, it is conceivable to have optimized mechanical oscillations or sound waves act in the region of atomization of the fuel in order to promote evaporation or further atomization that is as rapid as possible. In addition, better evaporation or atomization can take place from an oscillating surface of the evaporation element. In each case according to conditions, the introduction of energy for atomization/evaporation into the fuel by mechanical oscillations may be more effective than by transport of heat.

Of course, a heating element and a means for generation of mechanical oscillations can also be present in combination.

In a preferred embodiment the driving apparatus has a dispensing valve for dispensing the fuel, where the evaporation element is spaced at a distance from the dispensing valve. Especially preferably, the evaporation element is thermally isolated from the dispensing valve so that the amount of fuel dispensed in the dispensing valve does not become distorted. In another preferred embodiment the evaporation element is hydraulically arranged between the dispensing valve and the combustion chamber, so that the fuel can be dispensed in liquid form and then evaporated.

In one possible embodiment of the invention the evaporation element is arranged within the combustion chamber. Especially preferably in this case, injection of the fuel can be directed toward the evaporation element, so that an especially effective transfer of energy to the fuel, which is preferably already partially atomized, takes place. In particular in this case, the evaporation element can be designed to be small and energy saving.

In an alternative or supplemental embodiment, the fuel can be passed through the evaporation element. For example, the fuel line to the combustion chamber can be surrounded by a heating element. It can also be provided that the evaporation element is arranged directly in the region of injection of the fuel, in a kind of prechamber in the path of the injection. In this case the fuel coming from the injection line would first pass through the prechamber. Then the transfer of the energy of mechanical oscillations and/or heat would take place in the jet of fuel that was preferably already atomized by its exit from the injection line, for example from a nozzle.

In general, an evaporation element advantageously has means for increasing its surface area, where these are preferably fins, knobs and/or openings. This enables an especially effective transfer of energy from the evaporation element to the fuel.

In a generally advantageous embodiment of the invention, the evaporation element can be controlled via an electronic control unit, where in a preferred, but not necessary, further development a temperature sensor is connected with the control unit. Here, one can take into account the circumstance that an electrically driven evaporation element should at least not consume electric energy when sufficient evaporation and mixing of the fuel is already assured because of high ambient temperatures. The temperature sensor can, for example at appropriately low outside temperatures and/or a low fuel chamber temperature, provide the necessary information to begin activation of the evaporation element via the control electronics.

Especially advantageously, there is provided a first temperature sensor, which determines the temperature in the region of the combustion chamber, and a second temperature sensor, which determines the ambient temperature. This makes it possible to activate the evaporation element optimally when the environment is cold and the combustion chamber is cold, where deactivation of the evaporation element in order to save electric energy can take place after a warmup phase due to continuous operation of the apparatus and a correspondingly hot combustion chamber. Preferably, the performance of the evaporation element can be controlled in each case according to ambient temperature.

In a preferred embodiment it is provided that activation of the evaporation element take place by means of an actuation element, preferably a handle switch and/or a pressure switch. A handle switch here is understood to mean one that activates the evaporation element, optionally under the condition of other parameters such as outside temperature, when the apparatus is taken into the hand of a user, so that actuation can occur soon. The pressure switch can be provided in a front region of the apparatus and can be actuated by the contact of the apparatus pressing against a workpiece. Such a pressure switch can already be provided in order to serve as a safety device to prevent unintended actuation of the fastener driving apparatus.

In another embodiment of the invention the evaporation element can be activated directly by an actuation switch. Direct activation in this case takes place without regard to other parameters such as temperature or operating state. Such a switch can be provided in order to save costs, as the only possibility for activating the evaporation member. For example, in a simple model the control electronics could be omitted in this way, with ignition of the apparatus taking place, for example, via a piezoelectric igniter. However, the switch can also be present as a kind of override switch in addition to the control electronics.

Other advantages and features of the invention result from the embodiment examples described below and from the dependent claims.

Some embodiment examples of the invention are described below and explained in more detail by means of the attached drawings.

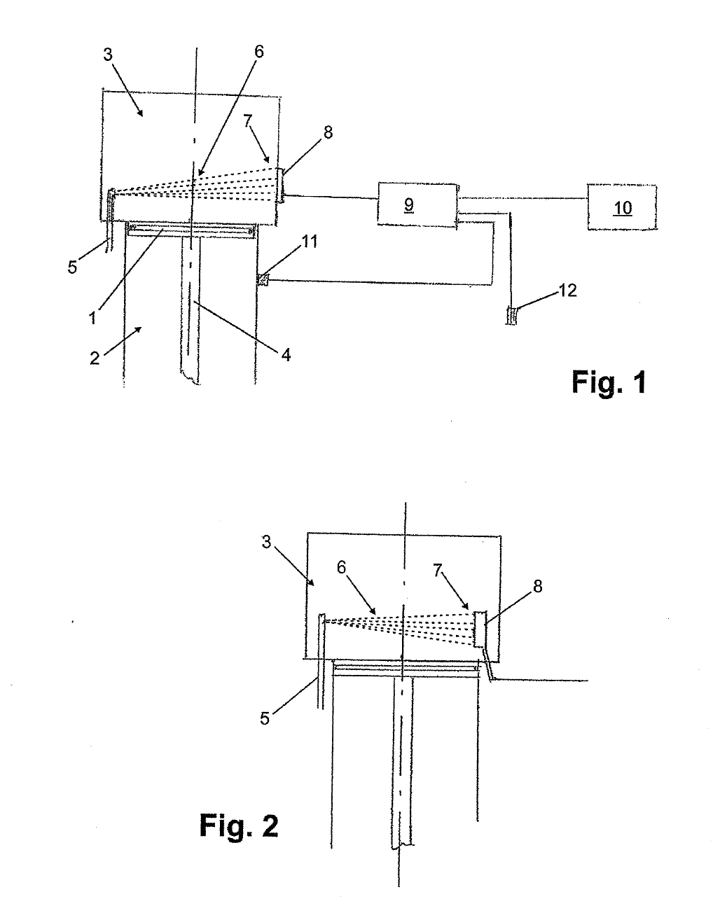

FIG. 1 shows a schematic sectional view of a fastener driving apparatus in accordance with the invention in a first embodiment.

FIG. 2 shows a schematic sectional view of a second embodiment of the invention.

In the driving apparatus shown in FIG. 1 a piston 1 is introduced into a cylinder 2 so that it can move linearly, where cylinder 2 connects in a known way to a combustion chamber 3 as a continuation thereof. Piston 1 has a driving ram 4 adjacent thereto in the direction that it is driven, by means of which a nail element or other fastening element (not shown) can be driven into a workpiece. The driving apparatus has, in a known way, a magazine to hold nail elements, one or more actuating switches, and a tank to store fuel or liquefied gas (not shown here).

The liquefied gas is sent into combustion chamber 3 by means of a gas line 5, which is arranged after a valve element for dispensing fuel. There it flows in a specific direction into the combustion chamber. In the example according to FIG. 1, the jet of fuel 6 flows in the essentially hollow cylindrical combustion chamber 3 in the radial direction from one end to the other, and the fuel jet 6 spreads in a specified way and strikes an impact region 7 of the opposite wall of the combustion chamber. On the outside of the impact region 7 an electrically driven active evaporation element 8 in the form of a heating element is placed on the wall of the combustion chamber. The impact region 7 of the wall of the combustion chamber 3 can be heated by the heating element 8, so that fuel striking the impact region 7 can absorb heat energy and evaporate in combustion chamber 3 more rapidly. It should be understood that the fuel jet 6 has greater or lesser evaporation at the moment of impact on region 7, in each case according to the temperature of line 5 and combustion chamber 3, where in general it is a mixture of gaseous and droplet fuel.

The heating element 8 is provided with electric energy via electronic control unit 9, which in turn is connected to a voltage source 10 in the form of an electrical energy storage means formed as a battery. Battery 10 is usually provided in the housing of this hand-held fastener driving apparatus, for example in the region of the handle, in the region of the magazine for nails, or in another region. Especially advantageously, the electric energy storage means is made as a lithium ion battery, in order to make available the greatest possible amount of energy in the shortest time with the lowest possible weight, as is advantageous for ergonomic operation of the active evaporation elements of fastener driving equipment in accordance with the invention. In embodiment examples that are not shown, the electric energy storage means is made as an iron-phosphorus battery or as a sulfur oxide battery.

The electronic control unit 9 is connected to two temperature sensors 11 and 12. The first temperature sensor 11 is arranged on one wall of the combustion chamber 3 next to the wall of cylinder 2 in order to measure the temperature of the apparatus. Temperature sensor 11 is situated far enough from the heating element so as not to be affected by its temperature. The purpose of the first temperature sensor 11 is to determine the general average heating of combustion chamber 3, so that placing it on cylinder wall 2 at a relatively large distance from heating element 8 is especially favorable.

The second temperature sensor 12 is arranged in an appropriate region of the housing of the driving apparatus in order to measure ambient temperature with as little influence from the temperature of the apparatus as possible.

Heating element 8 is controlled as follows:

Via the first temperature sensor 11, it is established in dependence on the apparatus temperature whether activation of evaporation element 8 is necessary. By measuring of the ambient temperature by the second temperature sensor 12, moreover, reference can be made to the temperature of the liquefied gas in the tank as well as to the temperatures of the lines. Correspondingly, the performance of the heating element 8 can be controlled in dependence on the requirements. In general, higher heating power of heating element 8 should be set at a lower ambient temperature. Basically, the second temperature sensor 12 can even be arranged directly on the tank for the liquefied gas, provided the tank is not designed as an exchangeable cartridge.

In the second embodiment of the invention, shown in FIG. 2, the heating element is not arranged on the outer wall of the combustion chamber as in FIG. 1, but rather within combustion chamber 3. For this, a guideway into combustion chamber 3 for the electrical line to the heating element 8 is required. Advantageous with this arrangement is the still faster reaction, since the thermal inertia of the combustion chamber wall is omitted.

The impact region 7 in this embodiment is formed directly by the surface of heating element 8. Heating element 8 can preferably have structures to increase its surface area in impact region 7, for example fins, knobs, openings, or the like.

Further control of the heating element arranged within combustion chamber 3 takes place as in the first embodiment example.

A typical limit temperature, starting with which the activation of the electrically driven evaporation element 8 occurs, lies in the range of 0° C. In each case according to the design of the combustion chamber and the fuel that is used, the temperature can, however, also be higher or lower than that. Basically, through the active evaporation element in accordance with the invention, the apparatus can be operated even at very low temperatures, even at temperatures that lie near or below the boiling point of the fuel. When configuring the capacity of the electric energy storage means one can in this connection take into consideration a preferred purpose of the apparatus.

1. A fastener driving apparatus comprising
a receptacle for a tank for storage of a fuel,
a combustion chamber that can be connected to the tank via a valve element, where the combustion chamber has a movable piston to advance a driving ram
an ignition device to ignite an air-fuel mixture in combustion chamber,
a supply line of the fuel to the combustion chambers, and an electrically driven evaporation element, wherein the evaporation element is provided in a region of the supply line.

2. The driving apparatus as in claim 1, wherein the evaporation element comprises an electrical heating element.

3. The driving apparatus as in claim 2, wherein the heating element comprises a PTC heater.

4. The driving apparatus as in claim 1, wherein the evaporation element comprises a means for generation of mechanical oscillations.

5. The driving apparatus as in claim 1, wherein the driving apparatus has a dispensing valve for dispensing the fuel, and where the evaporation element is at a distance from the dispensing valve.

6. The driving apparatus as in claim 1, wherein the evaporation element is hydraulically arranged between the dispensing valve and the combustion chamber.

7. The driving apparatus as in claim 1, wherein the evaporation element is arranged within the combustion chamber.

8. The driving apparatus as in claim 1, wherein the fuel is sent through the evaporation element.

9. The driving apparatus as in claim 1, wherein the operation element has means to increase its surface.

10. The driving apparatus as in claim 1, wherein the driving apparatus has an electronic control unit, via which the evaporation element can be controlled.

11. The driving apparatus as in claim 1, wherein the driving apparatus has a first temperature sensor, which determines the temperature in the region of the combustion chamber, and a second temperature sensor, which determines the ambient temperature.

12. The driving apparatus as in claim 1, wherein activation of the evaporation element takes place by means of an actuation element.

13. The driving apparatus as in claim 1, wherein the evaporation element can be directly activated via an actuation switch.

14. The driving apparatus according to claim 4, wherein the means for generation of mechanical oscillations comprises a high-frequency or ultrasound generator.

15. The driving apparatus of claim 5, wherein the evaporation element is thermally isolated from the dispensing valve.

16. The driving apparatus of claim 7, wherein injection of the fuel is directed onto the evaporation element.

17. The driving apparatus of claim 9, wherein the means to increase the surface comprise fins, knobs and/or openings.

18. The driving apparatus of claim 10, having a temperature sensor connected to the control unit.

19. The driving apparatus as in claim 2, wherein the driving apparatus has a dispensing valve for dispensing the fuel, and where the evaporation element is at a distance from the dispensing valve.

20. The driving apparatus of claim 19, wherein the evaporation element is thermally isolated from the dispensing valve.
